(19) United States
(12) Patent Application Publication
(10) Pub. No.: US 2008/0093139 A1
(43) Pub. Date: Apr. 24, 2008

(54) Drive for a vehicle, especially a tracked vehicle or a vehicle with wheel-based steering

(75) Inventors: Rolf Dobereiner, Augsburg (DE); Nikolaus Muller, Munchen (DE)

Correspondence Address: COHEN, PONTANI, LIEBERMAN & PAVANE, 551 FIFTH AVENUE, SUITE 1210, NEW YORK, NY, 10176, US

(73) Assignee: Renk Aktiengesellschaft, Augsburg (DE)

(21) Appl. No.: 11/821,737

(22) Filed: Jun. 25, 2007

(30) Foreign Application Priority Data
Jun. 26, 2006 (DE) 10 2006 029 571.4

(51) Int. Cl. B60R 16/02; B60K 1/00

(52) U.S. Cl. 180/65.3; 180/65.1

(57) ABSTRACT

A drive for a vehicle, especially a tracked vehicle or a vehicle with wheel-based steering, with at least one component which consumes electric energy and at least one power electronic component (power electronics) for providing the necessary electric energy, where the power electronics can be cooled with a fluid by the evaporative cooling process.

### BACKGROUND OF THE INVENTION

1. Field of the Invention

The invention pertains to a drive for a vehicle, especially for a tracked vehicle or a vehicle with wheel-based steering, of the type having at least one component which consumes electrical energy, and at least one primer electronic component which generates heat.

2. Description of the Related Art

An electromechanical drive system for a full-track vehicle is known from DE 37 28 171 C2. The power of an internal combustion engine is converted to electrical energy by a generator, sent to electric motors, and used again as mechanical drive power. For this purpose, an electric traction motor is provided, which drives a central shaft. The central shaft is connected by differential gear arrangements to each of the two chain drive wheels. To steer the tracked vehicle, an electric steering motor is provided, which superimposes its speed on the differential gear arrangements in opposite directions by way of a zero shaft.

A parallel hybrid drive for tracked vehicles is known from US 2005/187067, in which the electric motor, designed as a starter/generator, for example, can also be used when necessary to drive the vehicle. In such arrangements, the power of the electric motor is often much lower than that of the internal combustion engine. This is also referred to as a “mild hybrid layout”.

A power-branching hybrid drive for tracked vehicles is known from US 2007/102209. The prime power generator (a diesel engine or a gas turbine) and two electric motors are connected to each other by a planetary gear in such a way that the rpm's of the prime power producer are isolated from the rpm's of the transmission input. Nevertheless, a mechanical connection still exists so that high efficiency can be achieved. The integration of two electric motors makes it possible for one of the motors to be operated as a motor and the other as a generator. There is therefore no need to install traction batteries—an energy storage device designed especially to provide drive energy—in the vehicle. While the vehicle is idling, the prime power generator can be turned off. For a fast start, the vehicle can be driven off electrically, the electrical energy being provided by an APU (auxiliary power unit), also installed in the vehicle.

The generally known power-electronic components (power electronics) for providing electrical energy used today in powerpacks (drive systems having of an engine and a transmission unit) for tracked vehicles are mounted on a plate, through which cooling water flows so that the waste heat can be carried away. The top side of the components is exposed to the air, which is circulated by ventilators to avoid hotspots. Because of the multiple heat transfers via several housing walls from the cooling water to the point at which the waste heat originates in the component, a relatively large temperature difference is required between the cooling water and the component. A cooling water inlet temperature of no more than 70° C. is usually required.

It is known from DE-G 93 09 428 U1 that electronic components can be cooled by evaporative cooling.

### SUMMARY OF THE INVENTION

An object of the invention is to improve the cooling of the power electronics used in vehicles, especially in tracked vehicles or vehicles with wheel-based steering.

This task is accomplished according to the invention by cooling the power electronic component with a cooling fluid which evaporates when exposed to heat.

The power and control electronics for the electric motors of the (hybrid) drive, the transmission control, the prime power generator control, and the control for the generator of the APU can advantageously be integrated into the powerpack, consisting of the prime power generator, the powershift transmission, and the cooling system.

According to the invention, the power-electronic components (power electronics) are located in a separate, tightly sealed housing, which advantageously can be integrated into the transmission housing. It is especially advantageous for the power electronics to be cooled by evaporative cooling as known from G 93 09 428.0, for example. The fluid in which the electronic components are immersed in the housing has a boiling temperature which is below the critical operating temperature for these components. During the boiling process, the temperature of the fluid remains constant. The vapor condenses on the housing wall and, thus liquefied, is made available again to the boiling process. The vapor can be conducted alternatively to a condenser, which is exposed to ambient air and thus cooled. The ambient air can be taken from the mass flow of air of the cooling system and can simultaneously serve to ventilate the engine compartment.

Because, according to the invention, the power-electronic components (power electronics) are cooled independently of the cooling water, the limitation on the cooling water temperature is eliminated. Even at high outside temperatures (>50° C.), it is ensured that the electronic components will not become overheated. The inventively designed power electronics can therefore be integrated advantageously into the engine compartment or into the transmission housing, where temperatures of considerably above 100° C. can be present.

The total drive power of the vehicle can be divided in an appropriate ratio, which depends on the requirements on the vehicle, between the prime power generator and the APU. The APU can be advantageously integrated into the powerpack, because the dimensions of the prime power generator of the hybrid drive will be correspondingly smaller. For short peak power demands, the electric power of the APU can be supplied additionally via the hybrid unit to the drive (“boosting”). Whereas the APU runs continuously, the prime power generator can be advantageously turned off during long idle periods.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a schematic diagram of the drive elements of an inventive vehicle; and

FIG. 2 shows a schematic diagram of the drive elements in the engine compartment of an inventive vehicle.

### DETAILED DESCRIPTION OF THE PRESENTLY PREFERRED EMBODIMENTS

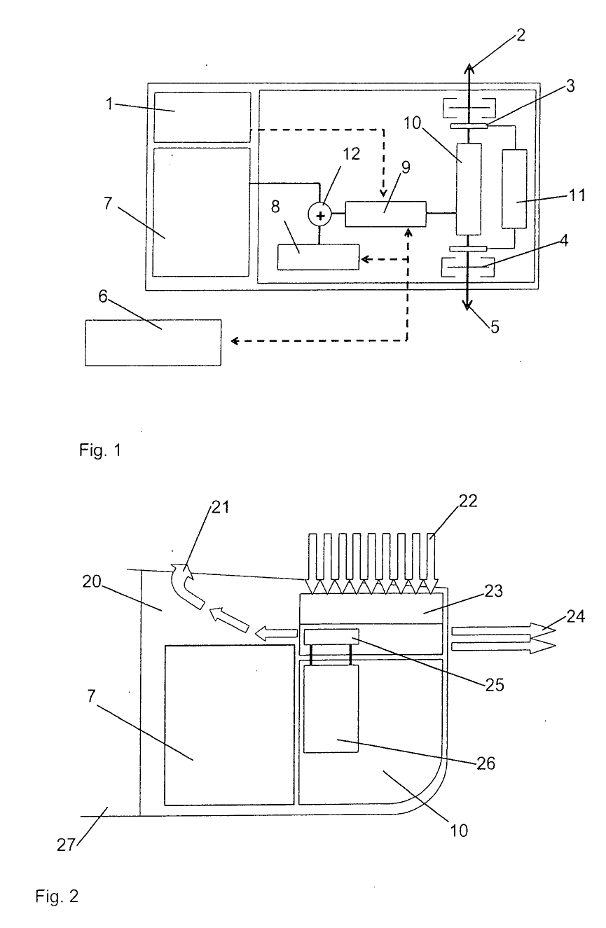

The drive unit of an exemplary vehicle shown schematically in FIG. 1 has a hybrid drive, consisting of a prime power generator 7, preferably a diesel engine or a gas turbine, which is connected by way of a hybrid unit 12 to two electric machines 8, 9. The electric machines 8, 9 can be operated both as generators and as electric motors.

One of the electric machines 9 is connected directly to a powershift transmission 10, shown by way of example. A differential gear 3 and a brake 4 are connected to each of the takeoffs 2, 5. By means of a steering motor 11, drive power can be transmitted via the differential gears 3 from one takeoff to the other 2, 5. As a result, the takeoffs rotate at different speeds, and the vehicle therefore turns. If the takeoffs 2, 5 are connected to sprocket wheels, the different rotational speeds are transmitted via the caterpillar tracks to the road. It is also possible, however, to drive the wheels of a vehicle which is steered by the wheel-based steering method. Further details on the hybrid drive and on the steering of tracked vehicles or vehicles with wheel-based steering can be found in US 2007/102209.

An auxiliary power unit 1 can also be seen in FIG. 1. This unit generates current by means of an additional prime power generator and an electrical generator. The auxiliary power unit 1 is also referred to as an APU. The current generated by the APU can also be sent to the electric motors 8, 9 and thus used to drive the vehicle.

A battery bank 6 can also be provided, which can be charged by the electric machines 8, 9 when they are operating in generator mode. As needed, the electrical energy from the battery bank 6 can be sent back to the electric machines 8, 9 again when these are being operated as drive motors.

To convert, control, and switch the electric currents and voltages, electronic components are necessary, which are referred as “power electronic” components or simply as “power electronics”.

FIG. 2 shows the power electronics provided for the vehicle being described here by way of example. A schematic side view of the engine compartment 20 of a vehicle 27 is illustrated. The prime power generator 7 and the transmission 10 are arranged compactly right next to each other. A cooling system 23, which is used to cool the transmission 10 and the prime power generator 7, is located above the transmission 10. Fans draw air 22 in from the environment of the vehicle 27 and conduct it through the cooling system 23. Some of this air is also used to ventilate the engine compartment 20. Some of the heated air is discharged as exhaust air 21 from the engine compartment, and the rest is discharged as exhaust air 24 from the cooling system.

It is especially advantageous to install the power electronics in the transmission 10, close to the electric motors 8, 9, which are also preferably located in the transmission housing 10. Because of the proximity of the power electronics to the electric motors 8, 9, the high electric drive power must be conducted over only a short distance through a high-voltage buffer circuit.

The power-electronic components 26 are preferably installed in a separate, tightly sealed housing and cooled with a fluid by the evaporative cooling process. The power-electronic components 26 are thus directly immersed in the preferably highly insulating fluid and heat this fluid until it boils. During the boiling process, the fluid remains at its boiling temperature, and some of the fluid evaporates. The vapor can condense on the housing wall and, thus liquefied, becomes available again for cooling.

The fluid is preferably selected so that it is a better insulator than air, which means that the electronic components can be mounted closer together. An evaporatively cooled power electronic unit therefore requires less space and can be integrated advantageously into the transmission housing of a vehicle, especially a tracked vehicle or a vehicle with wheel-based steering.

For the recooling and/or condensation of the vapor, a fluid/air heat exchanger or a condenser 25 can be provided. The fluid/air heat exchanger/condenser is connected to the housing of the power electronics 26 by one or more connecting lines and is preferably exposed to and cooled by the ambient air, which is preferably taken from the mass flow of air 22 passing through the cooling system 23. This air can simultaneously be used to ventilate the engine compartment 20.

Appropriate measures can be taken so that the pressure in the condenser or fluid/air heat exchanger 25 differs from the pressure in the housing of the power electronics 26. Because the boiling temperature is a function of pressure, favorable temperature levels appropriate for the condenser and for the housing of the power electronics can be selected.

Further details on the evaporative cooling process can be found in, for example, DE-G 93 09 428 U1.

Because the power electronics are cooled independently of the cooling water of the vehicle cooling system 23, there is no need to impose a limit on the temperature of the cooling water. If, for example, the electronic components can withstand maximum temperatures of 100-120° C., the cooling water temperature would have to be limited to 70-80° C. because of the multiple heat transfers. Because this limitation is eliminated when evaporative cooling is used, the vehicle cooling system 23 can be operated at a higher temperature. Because the temperature difference ΔT between cooling air and the water inlet temperature is thus increased, the cooling system therefore advantageously has a more powerful cooling effect on the engine, transmission, etc. Through evaporative cooling, it is ensured that, even at high ambient temperatures, the power electronics will not become overheated. For this reason, the power electronics can be advantageously installed inside the engine compartment/powerpack, for example, or inside the transmission housing of the vehicle. This option is especially advantageous in the case of tracked vehicles or vehicles with wheel-based steering, where peak temperatures of considerably above 100° C. can be present in the engine compartment/-powerpack or in the transmission housing.

If the power-electronic components are subject to a temperature limit of 80° C., for example, a cooling fluid with a corresponding boiling point is to be selected.

In the case of vehicles which require not only a main drive system but also an auxiliary power unit for supplying power to electrical consumers, it is advantageous in the case of a hybrid main drive for the necessary total drive power to be produced jointly by the prime power generator of the hybrid drive and the auxiliary power unit. In this case, the size of the prime power generator can be reduced to such an extent that the auxiliary power unit, the size of which will be increased correspondingly, can be accommodated in the space remaining in the engine compartment/powerpack of the vehicle. Thus the space previously occupied by the auxiliary power unit becomes free for other (useful) purposes.

The maximum drive power for accelerating a vehicle of this type is provided by the prime power generator of the hybrid drive (diesel engine, gas turbine, or some other heat engine), which drives the vehicle directly, and by the electric drive (one or more electric motors supplied with electrical energy by the auxiliary power unit), which boosts the acceleration of the vehicle.

The total drive power is preferably divided between the prime power generator of the hybrid drive and the auxiliary power unit in such a way that the electrical energy or power of the auxiliary power unit is sufficient to accelerate the vehicle within a predetermined time to a predetermined speed and simultaneously to start the prime power generator of the hybrid drive.

It is especially advantageous to divide the total drive power in such a way that that the prime power generator of the hybrid drive produces two-thirds of the power and the auxiliary power unit one-third of the power.

On the basis of a conventional vehicle with a prime power generator with an output of 500 kW (V8 diesel engine), for example, and an APU with an output of 40 kW (V2 diesel engine), a corresponding hybrid vehicle could be equipped with a prime power generator of 375 kW (V6 diesel engine) and an APU of 125 kW (e.g., a V4 diesel engine).

It is especially advantageous for the auxiliary power unit to be integrated into the engine compartment (powerpack) of a tracked vehicle or vehicle with wheel-based steering.

Integrating evaporatively cooled power electronics 26 into the transmission housing 10 makes it possible to obtain an especially advantageous drive arrangement. The power electronics would then also be accommodated in the engine compartment along with the prime power generator, the electric machine (capable of operating either as a motor or as a generator), the auxiliary power unit, and the powershift and steering transmission with transmission control unit. These assemblies together form an integrated, compact drive unit/powerpack. If it were possible to omit the transmission, the power electronics could be installed at some other point in the engine compartment rather than in the transmission housing.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive for a vehicle, the drive comprising:
at least one component which consumes electrical energy;
at least one power electronic component which generates heat; and
means for cooling the power electronic component with a cooling fluid which evaporates when exposed to heat.

2. The drive of claim 1 wherein vehicle has an engine compartment, the power electronic component being installed in the engine compartment.

3. The drive of claim 1 wherein the vehicle has a transmission housing, the power electronic component being installed in the transmission housing.

4. The drive of claim 1 comprising a plurality of power electronic components installed in a sealed housing which is immersed directly in the cooling fluid.

5. The drive according to claim 1 further comprising one of a fluid-air heat exchanger and a condenser for condensing evaporated cooling fluid.

6. The drive according to claim 5 wherein said one of a fluid-air heat exchanger and a condenser is cooled by ambient air.

7. The drive according to claim 5 further comprising:
a housing for said one of a fluid-air heat exchanger and a condenser;
a housing for said at least one power electronic component; and
means for maintaining a different pressure in the housing for said one of a fluid-air heat exchanger and a condenser than in said housing for the at least one power electronic component.

8. A drive for a vehicle having an engine compartment, the drive comprising:
a prime power generator in the engine compartment;
an electric machine which can operate as either a motor or a generator, the electric machine being driven as a generator by the prime power generator;
an auxiliary power unit which can drive the electric machine as a generator, the auxiliary power unit being located in the engine compartment; and
power electronics for switching and controlling the electric machine.

9. The drive of claim 8 further comprising a powershift and steering transmission connected to the electric machine.

10. The drive of claim 9 wherein the powershift and steering transmission comprises a transmission housing, the power electronics being installed in the transmission housing.
